(19) United States
(12) Patent Application Publication
(10) Pub. No.: US 2016/0050964 A1
(43) Pub. Date: Feb. 25, 2016

(54) ALL NATURAL JUICE BEVERAGE

(71) Applicant: Harvest Beverage Group LLC (d/b/a Juisi), North Salem, NY (US)

(72) Inventors: David W. Milburn, Middlebury, CT (US); Joseph C. Savino, North Salem, NY (US)

(21) Appl. No.: 14/467,137

(22) Filed: Aug. 25, 2014

(51) Int. Cl. A23L 2/04

(52) U.S. Cl. CPC A23L 2/04; A23V 2002/00

(57) ABSTRACT

A juice beverage includes 96.00% to 94.00% watermelon juice, 5.00% to 3.00% lime juice, and 2.50% to 0.50% beet juice. A method for making a juice beverage includes extracting watermelon juice from watermelons, extracting whole beet juice from whole beets, and adding the extracted whole beet juice to the extracted watermelon juice in a specified percentage by volume.

### BACKGROUND OF THE INVENTION

The present invention relates generally to beverages, and more particularly to an all natural juice beverage.

Fruit and vegetable juice consumption continues to increase in part because of technological change in juice processing and concentration methods. Flash pasteurization, improved thermal concentrating, freeze concentrating, blending, freezing, and drying or crystallization all contributed to this growth by providing better quality, better tasting and higher purity juice products which are more convenient to use. The current health awareness by consumers has also contributed to the consumption of fruit juices and other natural beverages.

A challenge of producing beverages which are acceptable to a broad range of consumers involves making a unique product having an acceptable flavor and aroma, acceptable appearance and satisfactory mouthfeel.

While the public seeks out all natural beverages to insure a healthier life, in general, food companies today are allowed to say “100% juice” on their labels, even though their juices contain additional additives, flavorings or preservatives. For example, one company that advertises “100% fruit juice” adds sodium (salt), flavoring, vitamin C and citric acid to preserve the juice for a longer shelf life. All of these added ingredients do nothing for a human body and in some cases can harm a human body.

Accordingly, what is needed is a 100% all natural juice beverage that remains visually pleasing and taste satisfying.

### SUMMARY OF THE INVENTION

The present invention is directed towards an all natural juice beverage.

In one aspect, the invention features a juice beverage including 90.00% to 99.99% watermelon juice, and 10.00% to 0.01% beet juice.

In another aspect, the invention features a juice beverage including 96.00% to 94.00% watermelon juice, 5.00% to 3.00% lime juice, and 2.50% to 0.50% beet juice.

In still another aspect, the invention features a method for making a beverage including extracting watermelon juice from watermelons, extracting whole beet juice from whole beets, and adding the extracted whole beet juice to the extracted watermelon juice in a specified percentage by volume.

Embodiments of the invention may include one or more of the following advantages.

The all natural watermelon juice beverage of the present invention holds a red “color cloud” in a clear bottle for an extended period of time.

Organic red beet juice added in small amounts to a watermelon juice does not change a flavor of the watermelon juice and acts as a color stabilizer in the watermelon juice.

These and other features and advantages will be apparent from a reading of the following detailed description and a review of the associated drawings. It is to be understood that both the foregoing general description and the following detailed description are explanatory only and are not restrictive of aspects as claimed.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Primary Juice Component

Any juice can be used to make the beverage of this invention. For example, apple, cranberry, pear, peach, plum, apricot, nectarine, grape, cherry, currant, raspberry, gooseberry, blackberry, blueberry, strawberry, lemon, orange, grapefruit, tomato, lettuce, celery, spinach, cabbage, watercress, dandelion, rhubarb, carrot, beet, cucumber, pineapple, custard-apple, cocona, pomegranate, guava, kiwi, mango, papaya, banana, watermelon and cantaloupe can be used.

Although the following description of this invention is described with particular reference to making a watermelon juice beverage, it will be understood that the process is not limited thereto. Thus, the process is equally applicable to other fruit juices, e.g., pear, cranberry and grape juices, as well as vegetable juices.

Watermelons are washed with a high-pressure water system to remove any earth particles. The washed watermelons are placed in a cold storage area. The temperature of the cold storage area is preferably less than or equal to 41° F. (5° C.).

Skins of the washed watermelons are removed manually and/or using automatic mechanical skinning equipment. The skinned watermelons are then sliced either manually and/or using automatic slicing equipment. In a preferred embodiment, the washed watermelons are sliced into three inch (3″) to five inch (5″) pieces, depending upon the size of the unsliced washed watermelons. The sliced watermelons are placed into transportable containers filled with cold water. The cold water within the transportable containers enables each slice of watermelon to float and prevents individual watermelon slices from crushing each other.

At this stage, the watermelon slices are ready for cold pressed juice extraction. Watermelon slices are inserted into perforated “press bags,” placed in a hydraulic press, and pressed on opposite sides of the press bags. In a preferred embodiment, the hydraulic press exerts a pressure 500 to 2,000 pounds per square inch (PSI) to opposite sides of the press bags. As the hydraulic press applies pressure to the press bags, watermelon juice is collected in one or more collection bins linked to the hydraulic press. Each of the one or more collection bins is linked to a main batch vessel. In a preferred embodiment, extracted watermelon juice in the one or more collection bins is pumped to the main batch vessel.

Secondary Juice Component

Whole red beets are washed with a high-pressure water system to remove any earth particles. The washed whole red beets are placed in a cold storage area. The temperature of the cold storage area is preferably less than or equal to 41° F. (5° C.)

The washed whole red beets are placed into grinding equipment. The grinding equipment produces small particle red beets. The small particle red beets are then ready for cold pressed juice extraction.

The small particle red beets are inserted into perforated press bags, placed in a hydraulic press, and pressed on opposite sides of the press bags. In a preferred embodiment, the hydraulic press exerts a pressure 500 to 2,000 pounds per square inch (PSI) to opposite sides of the press bags. As the hydraulic press applies pressure to press bags, red beet juice is collected in one or more collection bins linked to the hydraulic press. Each of the one or more collection bins is linked to a secondary batch vessel. In a preferred embodiment, extracted red beet juice in the one or more collection bins is pumped to the secondary batch vessel.

Tertiary Juice Component

In a preferred embodiment, lime juice is added to the formulation to lower a pH of final product, extending shelf life up to five weeks.

Whole limes are washed with a high-pressure water system to remove any earth particles. The washed whole limes are placed in a cold storage area. The temperature of the cold storage area is preferably has a temperature of less than or equal to 41° F. (5° C.).

The washed whole limes are placed into slicing/grinding equipment. Whole lime juice produced from the slicing/grinding equipment is collected into one or more a tertiary collection bins.

Blending

A ratio of 90.00% to 99.99% watermelon juice to 10.00% to 0.01% beet juice is utilized. In a preferred embodiment, the all natural fruit beverage of the present invention includes 96.00% to 94.00% watermelon juice, 5.00% to 3.00% lime juice and 2.50% to 0.50% beet juice.

Packaging

Once prepared, the all natural fruit beverage of the present invention is filled into plastic clear bottles with a tamper evident cap and subjected to pressure pasteurization (HPP) in a cold room with a temperature of less than or equal to 41° F. (5° C.). More specifically, the filled bottles are submerged into a water tank. The water tank is subject to up to 87,000 PSI for a specific time period. In a preferred embodiment, the specific time period is two minutes, i.e., 120 seconds. The bottles are then removed and ready for shipment.

Subjecting the bottled product to pressure pasteurization maintains the flavor, color and nutrients of the all natural fruit beverage, as well as reducing potential contaminants (e.g., pathogens) and extending its shelf life.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

What is claimed is:

1. A juice beverage comprising:
90. 00% to 99.99% watermelon juice; and
10.00% to 0.01% beet juice.

2. The juice beverage of claim 1 further comprising lime juice.

3. A juice beverage comprising:
96. 00% to 94.00% watermelon juice;
5. 00% to 3.00% lime juice; and
2.50% to 0.50% beet juice.

4. The juice beverage of claim 3 wherein the percentages are by volume.

5. A method for making a juice beverage comprising:
extracting watermelon juice from watermelons;
extracting whole beet juice from whole beets; and
adding the extracted whole beet juice to the extracted watermelon juice in a specified percentage by volume.

6. The method of claim 5 wherein extracting watermelon juice from the watermelons comprises:
washing the watermelons;
placing the washed watermelons in a cold storage area;
removing skins of the washed watermelons;
slicing the skinned watermelons;
placing the sliced skinned watermelons in perforated press bags;
subjecting the press bags to hydraulic pressure; and
collecting the watermelon juice.

7. The method of claim 6 wherein the cold storage area has a temperature of less than or equal to 41° F. (5° C.).

8. The method of claim 6 wherein the hydraulic pressure is 500 to 2,000 pounds per square inch (PSI).

9. The method of claim 5 wherein extracting whole beet juice from the whole beets comprises:
washing the whole beets;
placing the washed whole beets in a cold storage area;
grinding the washed whole beets into small pieces;
placing the small pieces of whole beets in perforated press bags;
subjecting the press bags to hydraulic pressure; and
collecting the beet juice.

10. The method of claim 9 wherein the cold storage area has a temperature of less than or equal to 41° F. (5° C.).

11. The method of claim 9 wherein the hydraulic pressure is 500 to 2,000 pounds per square inch (PSI).

12. The method of claim 5 wherein specified percentage by volume is 90.00% to 99.99% watermelon juice and 10.00% to 0.01% beet juice.

13. The method of claim 5 further comprising:
extracting lime juice from whole limes; and
adding the extracted whole lime juice to the extracted watermelon juice and extracted beet juice in a specified percentage by volume.

14. The method of claim 13 wherein extracting lime juice from whole limes comprises:
washing the whole limes;
placing the washed whole limes in a cold storage area;
grinding the washed whole limes; and
collecting the lime juice.

15. The method of claim 14 wherein the cold storage area has a temperature of less than or equal to 41° F. (5° C.).

16. The method of claim 13 wherein the specified percentage by volume is 96.00% to 94.00% watermelon juice, 5.00% to 3.00% lime juice and 2.50% to 0.50% beet juice.

17. The method of claim 5 further comprising bottling the whole beet juice and watermelon juice into plastic clear bottles.

18. The method of claim 17 further comprising subjecting the whole beet juice and watermelon juice in the plastic clear bottles to pressure pasteurization (HPP).
